(19) United States
(12) Patent Application Publication
(10) Pub. No.: US 2005/0112331 A1
(43) Pub. Date: May 26, 2005

(54) Multiwall sheets and methods for manufacturing thereof

(76) Inventors: Constantin Donea, Evansville, IN (US); Hendrik Cornelus Jacobus de Nooijer, Middelburg (NL); Herb Hummel, Long Sault (CA); Robert Dirk van de Grampel, Bergen op Zoom (NL); Constant Peek, Tilburg (NL)

Correspondence Address: CANTOR COLBURN, LLP, 55 GRIFFIN ROAD SOUTH, BLOOMFIELD, CT, 06002, US

(21) Appl. No.: 10/723,276

(22) Filed: Nov. 25, 2003

(51) Int. Cl. B32B 3/00

(52) U.S. Cl. 428/166; 428/188

(57) ABSTRACT

Disclosed herein is a multiwall sheet comprising a first sheet having a first side and a second side, wherein the first sheet comprises a thermoplastic polymer and an electrically conductive filler, and wherein the first side of the first sheet is disposed upon a first side of a plurality of ribs; wherein the second sheet comprises a thermoplastic polymer and an electrically conductive filler, wherein the first side of the second sheet is disposed upon a second side of the plurality of ribs, and wherein the first side of the plurality of ribs is opposed to the second side of the plurality of ribs, and wherein the first side of the plurality of ribs is opposed to the second side of the plurality of ribs.

### BACKGROUND

This disclosure relates to multiwall sheets and methods for manufacturing thereof. In particular this disclosure relates to antistatic multiwall sheets and methods for manufacture thereof.

Articles made from thermoplastic polymers are commonly utilized in material-handling and electronic devices such as packaging, chip carriers, printers and photocopier components where electrostatic dissipation is an important requirement. Many polymers or blends of polymers are relatively non-conductive. As such, this can result in a static charge build-up during processing and use of the polymer. The static charge build-up can attract small dust particles, and can thus interfere with a smooth surface appearance. These dust particles may also cause a decrease in the transparency of the article. In addition, the electrostatic charge can be a serious obstacle in the production process of such polymers. Electrostatic dissipation (hereinafter ESD) is defined as a transfer of electrostatic charge between bodies at different potentials caused by direct contact or induced by an electrostatic field. As electronic devices become smaller and faster, their sensitivity to static discharge increases and the necessity for increased rates of ESD becomes vital.

Thermoplastic polymers having ESD properties generally use low molecular weight additives such as ammonium salts. These additives tend to leach out with time and further lose their ESD properties upon exposure to moisture. It is therefore desirable to produce polymeric electrostatically dissipative sheets that can retain their ESD properties for extended periods of time.

### SUMMARY

Disclosed herein is a multiwall sheet comprising a first sheet having a first side and a second side, wherein the first sheet comprises a thermoplastic polymer and an electrically conductive filler, and wherein the first side of the first sheet is disposed upon a first side of a plurality of ribs; and a second sheet having a first side and a second side, wherein the second sheet comprises a thermoplastic polymer and an electrically conductive filler, wherein the first side of the second sheet is disposed upon a second side of the plurality of ribs, and wherein the first side of the plurality of ribs is opposed to the second side of the plurality of ribs.

Disclosed herein too is a method of manufacturing an electrically conductive multiwall sheet comprising melt blending a thermoplastic polymer with an electrically conductive filler to form an electrically conductive composition; and forming the electrically conductive composition into a multiwall sheet, wherein the multiwall sheet comprises a first sheet having a first side and a second side, wherein the first sheet comprises a thermoplastic polymer and an electrically conductive filler, and wherein the first side of the first sheet is disposed upon a first side of a plurality of ribs; and a second sheet having a first side and a second side, wherein the second sheet comprises a thermoplastic polymer and an electrically conductive filler, wherein the first side of the second sheet is disposed upon the second side of the plurality of ribs, and wherein the first side of the plurality of ribs is opposed to the second side of the plurality of ribs.

Disclosed herein too is a method of manufacturing an electrically conductive multiwall sheet comprising forming a thermoplastic polymer into a multiwall sheet, wherein the multiwall sheet comprises a first sheet having a first side and a second side, wherein the first side of the first sheet is disposed upon a first side of a plurality of ribs; and a second sheet having a first side and a second side, wherein the first side of the second sheet is disposed upon the second side of the plurality of ribs, wherein the first side of the plurality of ribs is opposed to the second side of the plurality of ribs; and coating the second side of the first and/or second sheet with a conductive coating having a surface resistivity of less than or equal to about 10¹¹ ohm/sq.

Disclosed herein too is a method for manufacturing a multilayered multiwall sheet comprising co-extruding a multilayered multiwall sheet comprising a first sheet having a first side and a second side, wherein the first sheet comprises a thermoplastic polymer and an electrically conductive filler, and wherein the first side of the first sheet is disposed upon a first side of a plurality of ribs; and a second sheet having a first side and a second side, wherein the second sheet comprises a thermoplastic polymer and an electrically conductive filler, wherein the first side of the second sheet is disposed upon the second side of the plurality of ribs, and wherein the first side of the plurality of ribs is opposed to the second side of the plurality of ribs.

### FIGURES

FIG. 1 is a schematic depicting a multiwall sheet; and

FIG. 2 represents various configurations of multiwall sheets.

### DETAILED DESCRIPTION OF PREFERRED EMBODIMENTS

Disclosed herein are multiwall sheets that have surface resistivities of less than or equal to about 1×10¹¹ ohms/square (ohm/sq) and which can be advantageously used to prevent the accumulation of dust and static charges on the packages that are used to protect and transport electronic devices. The multiwall sheets comprise a thermoplastic polymer and an electrically conductive filler. These multiwall sheets can be advantageously used as separator panels in automotive assembly plants.

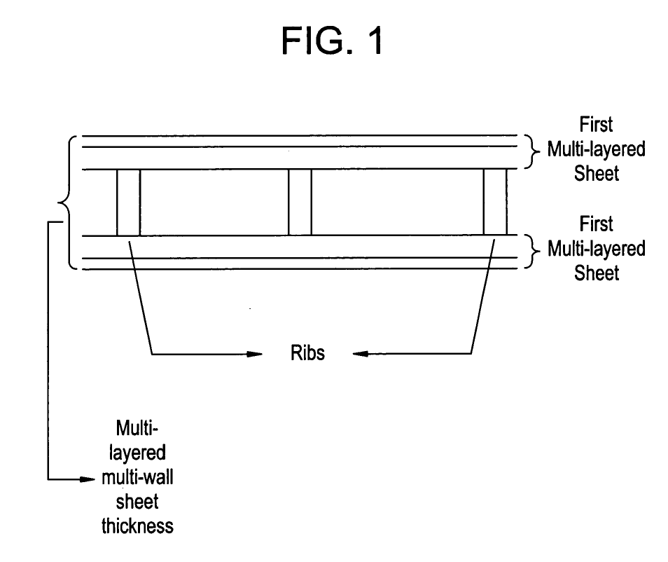

Referring now to FIG. 1, a multiwall sheet multiwall sheet comprises a first sheet having a first side and a second side, wherein the first sheet comprises a thermoplastic polymer and an electrically conductive filler, and wherein the first sheet is disposed upon a first side of a plurality of ribs, wherein the ribs have a first side and a second side; and a second sheet having a first side and a second side, wherein the second sheet comprises a thermoplastic polymer and an electrically conductive filler, wherein the first side of the second sheet is disposed upon the second side of the plurality of ribs.

The multiwall sheet has air pockets in between the ribs. Both the ribs and the sheet are manufactured from a thermoplastic polymer. In one embodiment, the plurality of ribs comprise a first and a second side that are not fused with the first surfaces of the first and second sheet respectively, but are in physical contact the first and the second sheet respectively. In another embodiment, the plurality of ribs may be fused with the first surfaces of the first and/or the second sheet of the multiwall sheet. In one embodiment, both the first sheet and the second sheet may consist of a single layer manufactured from a thermoplastic polymer. The ribs may have a cross-section having any desired geometry such as rectangular, circular, triangular, square, rhombohedral, polygonal, or the like, or a combination comprising at least one of the foregoing geometries.

In another embodiment, the first sheet and/or the second sheet may comprise multiple layers disposed upon the second surfaces of the respective sheets. As stated above, the second surfaces are opposed to the first surfaces that are in contact with the ribs. Such a multiwall sheet is termed a multilayered multiwall sheet. If the first and second sheet of the multiwall sheet comprise multiple layers, the layer furthest from the surface in contact with the ribs is called a cap layer. In yet another embodiment, either the first or the second sheet may comprise multiple layers, while the other sheet consists of a single layer. If the first sheet and the second sheet each consist of only a single layer, then it is desirable for the respective layers to have a surface resistivity of less than or equal to about 1×10¹¹ ohm/sq. If the first sheet and/or the second sheet each comprise multiple layers, then it is desirable for the respective cap layer(s) to have a surface resistivity of less than or equal to about 1×10¹¹ ohm/sq.

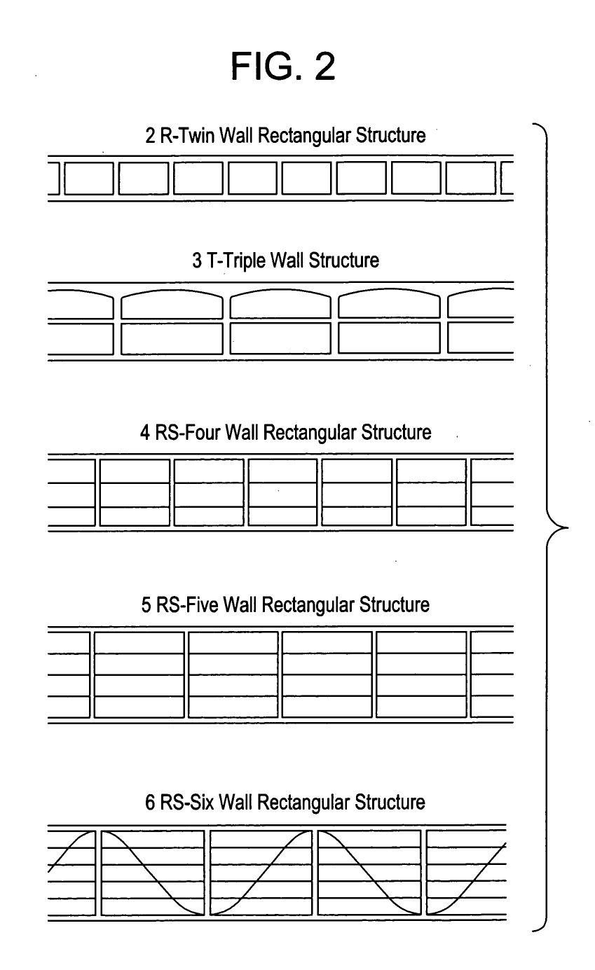

FIG. 2 depicts various embodiments for the electrically conductive multiwall sheets. In these embodiments, one of more sheets are disposed between and substantially parallel to the first and the second sheets in the multiwall sheets. These sheets may be segmented. In other words, they are not continuous as are the first and the second sheets.

As stated above, both, the first and the second sheet comprise thermoplastic polymers. Thermoplastic polymers that may be used are oligomers, polymers, ionomers, dendrimers, copolymers such as block copolymers, graft copolymers, star block copolymers, random copolymers, or the like, or combinations comprising at least one of the foregoing polymers. Suitable examples of thermoplastic polymers that can be used as the first and the second sheet are polyacetals, polyacrylics, polycarbonates polystyrenes, polyesters, polyamides, polyamideimides, polyarylates, polyarylsulfones, polyethersulfones, polyphenylene sulfides, polysulfones, polyimides, polyetherimides, polytetrafluoroethylenes, polytherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or combinations comprising at least one of the foregoing thermoplastic polymers.

Blends of thermoplastic polymers may also be used. Examples of blends of thermoplastic polymers include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyethylene/nylon, polyethylene/polyacetal, and the like, and mixtures comprising at least one of the foregoing blends of thermoplastic polymers.

The thermoplastic polymers used in the first and second sheets may also contain thermosetting polymers if desired. Examples of thermosetting polymers are polyurethanes, natural rubber, synthetic rubber, epoxy, phenolic, polyesters, polyamides, silicones, and the like, and mixtures comprising any one of the foregoing thermosetting polymers.

The preferred thermoplastic polymers for use in the first and the second sheet are polycarbonates, copolyestercarbonates, blends of polyesters with polycarbonates, or copolymers of polycarbonate and polysiloxane.

As used herein, the terms “polycarbonate”, “polycarbonate multiwall sheet”, and “multiwall sheet comprising aromatic carbonate chain units” includes multiwall sheets having structural units of the formula (I): 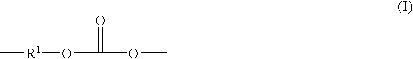
in which greater than or equal to about 60 percent of the total number of R¹ groups are aromatic thermoplastic radicals and the balance thereof are aliphatic, alicyclic, or aromatic radicals. Preferably, R¹ is an aromatic thermoplastic radical and, more preferably, a radical of the formula (II):
-A¹-Y¹-A² (II)
wherein each of A¹ and A² is a monocyclic divalent aryl radical and Y¹ is a bridging radical having zero, one, or two atoms which separate A¹ from A². In an exemplary embodiment, one atom separates A¹ from A². Illustrative examples of the Y¹ radicals are —O—, —S—, —S(O)—, —S(O)₂—, —C(O)—, methylene, cyclohexyl-methylene, 2-[2,2,1]-bicycloheptylidene, ethylidene, isopropylidene, neopentylidene, cyclohexylidene, cyclopentadecylidene, cyclododecylidene, adamantylidene, or the like. In another embodiment, zero atoms separate A¹ from A², with an illustrative example being biphenyl. The bridging radical Y¹ can be a saturated hydrocarbon group such as methylene, cyclohexylidene or isopropylidene.

Polycarbonates may be produced by the Schotten-Bauman interfacial reaction of the carbonate precursor with dihydroxy compounds. Typically, an aqueous base such as sodium hydroxide, potassium hydroxide, calcium hydroxide, or the like, is mixed with an thermoplastic, water immiscible solvent such as benzene, toluene, carbon disulfide, or dichloromethane, which contains the dihydroxy compound. A phase transfer agent is generally used to facilitate the reaction. Molecular weight regulators may be added either singly or in admixture to the reactant mixture. Branching agents, described forthwith may also be added singly or in admixture.

Polycarbonates can be produced by the interfacial reaction of dihydroxy compounds in which only one atom separates A¹ and A². As used herein, the term “dihydroxy compound” includes, for example, bisphenol compounds having general formula (III) as follows: 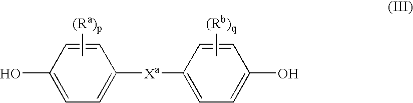
wherein R^{a} and R^{b} each independently represent hydrogen, a halogen atom, preferably bromine, or a monovalent hydrocarbon group, p and q are each independently integers from 0 to 4, and X^{a} represents one of the groups of formula (IV): 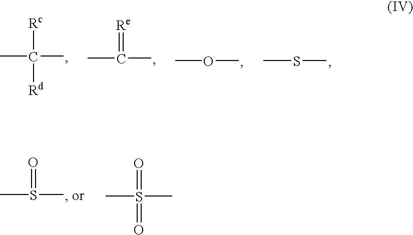
wherein R^{c} and R^{d} each independently represent a hydrogen atom or a monovalent linear or cyclic hydrocarbon group, and R^{e} is a divalent hydrocarbon group, oxygen, or sulfur.

Examples of the types of bisphenol compounds that may be represented by formula (III) include the bis(hydroxyaryl)alkane series such as, 1,1-bis(4-hydroxyphenyl)methane, 1,1-bis(4-hydroxyphenyl)ethane, 2,2-bis(4-hydroxyphenyl)propane (or bisphenol-A), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, bis(4-hydroxyphenyl)phenylmethane, 2,2-bis(4-hydroxy-1-methylphenyl)propane, 1,1-bis(4-hydroxy-t-butylphenyl)propane, 2,2-bis(4-hydroxy-3-bromophenyl)propane, or the like; bis(hydroxyaryl)cycloalkane series such as, 1,1-bis(4-hydroxyphenyl)cyclopentane, 1,1-bis(4-hydroxyphenyl)cyclohexane, or the like, or combinations comprising at least one of the foregoing bisphenol compounds.

Other bisphenol compounds that may be represented by formula (III) include those where X is —O—, —S—, —SO— or —S(O)₂—. Some examples of such bisphenol compounds are bis(hydroxyaryl)ethers such as 4,4′-dihydroxy diphenylether, 4,4′-dihydroxy-3,3′-dimethylphenyl ether, or the like; bis(hydroxy diaryl)sulfides, such as 4,4′-dihydroxy diphenyl sulfide, 4,4′-dihydroxy-3,3′-dimethyl diphenyl sulfide, or the like; bis(hydroxy diaryl)sulfoxides, such as, 4,4′-dihydroxy diphenyl sulfoxides, 4,4′-dihydroxy-3,3′-dimethyl diphenyl sulfoxides, or the like; bis(hydroxy diaryl)sulfones, such as 4,4′-dihydroxy diphenyl sulfone, 4,4′-dihydroxy-3,3′-dimethyl diphenyl sulfone, or the like; or combinations comprising at least one of the foregoing bisphenol compounds.

Other bisphenol compounds that may be utilized in the polycondensation of polycarbonate are represented by the formula (V) 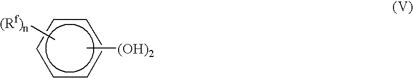
wherein, R^{f}, is a halogen atom of a hydrocarbon group having 1 to 10 carbon atoms or a halogen substituted hydrocarbon group; n is a value from 0 to 4. When n is at least 2, R^{f} may be the same or different. Examples of bisphenol compounds that may be represented by the formula (V), are resorcinol, substituted resorcinol compounds such as 5-methyl resorcin, 5-ethyl resorcin, 5-propyl resorcin, 5-butyl resorcin, 5-t-butyl resorcin, 5-phenyl resorcin, 5-cumyl resorcin, or the like; catechol, hydroquinone, substituted hydroquinones, such as 3-methyl hydroquinone, 3-ethyl hydroquinone, 3-propyl hydroquinone, 3-butyl hydroquinone, 3-t-butyl hydroquinone, 3-phenyl hydroquinone, 3-cumyl hydroquinone, or the like; or combinations comprising at least one of the foregoing bisphenol compounds.

Bisphenol compounds such as 2,2,2′,2′-tetrahydro-3,3,3′, 3′-tetramethyl-1,1′-spirobi-[IH-indene]-6,6′-diol represented by the following formula (VI) may also be used.

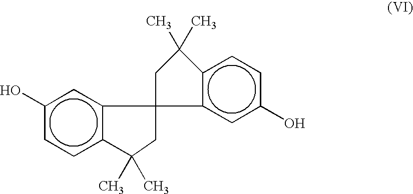

Suitable polycarbonates further include those derived from bisphenols containing alkyl cyclohexane units. Such polycarbonates have structural units corresponding to the formula (VII) 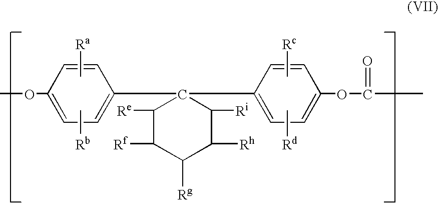
wherein R^{a}-R^{d} are each independently hydrogen, C₁-C₁₂ hydrocarbyl, or halogen; and R^{e}-Rⁱ are each independently hydrogen, C₁-C₁₂ hydrocarbyl. As used herein, “hydrocarbyl” refers to a residue that contains only carbon and hydrogen. The residue may be aliphatic or aromatic, straight-chain, cyclic, bicyclic, branched, saturated, or unsaturated. The hydrocarbyl residue may contain heteroatoms over and above the carbon and hydrogen members of the substituent residue. Thus, when specifically noted as containing such heteroatoms, the hydrocarbyl residue may also contain carbonyl groups, amino groups, hydroxyl groups, or the like, or it may contain heteroatoms within the backbone of the hydrocarbyl residue. Alkyl cyclohexane containing bisphenols, for example the reaction product of two moles of a phenol with one mole of a hydrogenated isophorone, are useful for making polycarbonate polymer s with high glass transition temperatures and high heat distortion temperatures. Such isophorone bisphenol-containing polycarbonates have structural units corresponding to the formula (VIII) 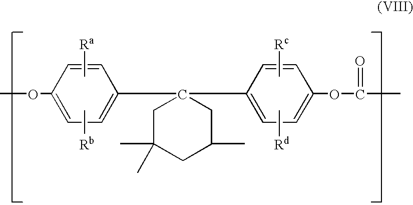
wherein R^{a}-R^{d} are as defined above. These isophorone bisphenol based polymer s, including polycarbonate copolymers made containing non-alkyl cyclohexane bisphenols and blends of alkyl cyclohexyl bisphenol containing polycarbonates with non-alkyl cyclohexyl bisphenol polycarbonates, are supplied by Bayer Co. under the APEC trade name. The preferred bisphenol compound is bisphenol A.

In one embodiment, the dihydroxy compound may be reacted with a hydroxyaryl-terminated poly(diorganosiloxane) to create a polycarbonate-polysiloxane copolymer. Preferably the polycarbonate-poly(diorganosiloxane) copolymers are made by introducing phosgene under interfacial reaction conditions into a mixture of a dihydroxy compound, such as BPA, and a hydroxyaryl-terminated poly(diorganosiloxane). The polymerization of the reactants can be facilitated by use of a tertiary amine catalyst or a phase transfer catalyst.

The hydroxyaryl-terminated poly(diorganosiloxane) can be made by effecting a platinum catalyzed addition between a siloxane hydride of the formula (IX), 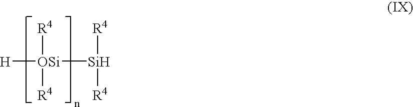
and an aliphatically unsaturated monohydric phenol wherein R⁴ is, for example, C₍₁₋₈₎ alkyl radicals, haloalkyl radicals such as trifluoropropyl and cyanoalkyl radicals; aryl radicals such as phenyl, chlorophenyl and tolyl. R⁴ is preferably methyl, or a mixture of methyl and trifluoropropyl, or a mixture of methyl and phenyl.

Some of the aliphatically unsaturated monohydric phenols, which can be used to make the hydroxyaryl-terminated poly(diorganosiloxane)s are, for example, eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol, 2-allyl-4,6-dimethylphenol, or the like, or a combination comprising at least one of the foregoing.

Typical carbonate precursors include the carbonyl halides, for example carbonyl chloride (phosgene), and carbonyl bromide; the bis-haloformates, for example the bis-haloformates of dihydric phenols such as bisphenol A, hydroquinone, or the like, and the bis-haloformates of glycols such as ethylene glycol and neopentyl glycol; and the diaryl carbonates, such as diphenyl carbonate, di(tolyl)carbonate, and di(naphthyl)carbonate. The preferred carbonate precursor for the interfacial reaction is carbonyl chloride.

It is also possible to employ polycarbonates resulting from the polymerization of two or more different dihydric phenols or a copolymer of a dihydric phenol with a glycol or with a hydroxy- or acid-terminated polyester or with a dibasic acid or with a hydroxy acid or with an aliphatic diacid in the event a carbonate copolymer rather than a homopolymer is desired for use. Generally, useful aliphatic diacids have about 2 to about 40 carbons. A preferred aliphatic diacid is dodecanedioic acid.

Branched polycarbonates, as well as blends of linear polycarbonate and a branched polycarbonate may also be used in the first and second sheet. The branched polycarbonates may be prepared by adding a branching agent during polymerization. These branching agents may comprise polyfunctional thermoplastic compounds containing at least three functional groups, which may be hydroxyl, carboxyl, carboxylic anhydride, haloformyl, and combinations comprising at least one of the foregoing branching agents. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) α,α-dimethyl benzyl)phenol), 4-chloroformyl phthalic anhydride, trimesic acid, benzophenone tetracarboxylic acid, or the like, or combinations comprising at least one of the foregoing branching agents. The branching agents may be added at a level of about 0.05 to about 4.0 weight percent (wt %), based upon the total weight of the polycarbonate in a given layer.

In one embodiment, the polycarbonate may be produced by a melt polycondensation reaction between a dihydroxy compound and a carbonic acid diester. Examples of the carbonic acid diesters that may be utilized to produce the polycarbonates are diphenyl carbonate, bis(2,4-dichlorophenyl)carbonate, bis(2,4,6-trichlorophenyl) carbonate, bis(2-cyanophenyl)carbonate, bis(o-nitrophenyl) carbonate, ditolyl carbonate, m-cresyl carbonate, dinaphthyl carbonate, bis(diphenyl) carbonate, diethyl carbonate, dimethyl carbonate, dibutyl carbonate, dicyclohexyl carbonate, bis(o-methoxycarbonylphenyl)carbonate, bis(o-ethoxycarbonylphenyl)carbonate, bis(o-propoxycarbonylphenyl)carbonate, bis-ortho methoxy phenyl carbonate, bis(o-butoxycarbonylphenyl)carbonate, bis(isobutoxycarbonylphenyl)carbonate, o-methoxycarbonylphenyl-o-ethoxycarbonylphenylcarbonate, bis o-(tert-butoxycarbonylphenyl)carbonate, o-ethylphenyl-o-methoxycarbonylphenyl carbonate, p-(tertbutylphenyl)-o-(tert-butoxycarbonylphenyl)carbonate, bis-methyl salicyl carbonate, bis-ethyl salicyl carbonate, bis-propyl salicyl carbonate, bis-butyl salicyl carbonate, bis-benzyl salicyl carbonate, bis-methyl 4-chlorosalicyl carbonate or the like, or combinations comprising at least one of the foregoing carbonic acid diesters. The preferred carbonic acid diester is diphenyl carbonate or bis-methyl salicyl carbonate.

Preferably, the weight average molecular weight of the polycarbonate is about 3,000 to about 1,000,000 grams/mole (g/mole). In one embodiment, the polycarbonate has a weight average molecular weight of about 10,000 to about 100,000 g/mole. In another embodiment, the polycarbonate has a weight average molecular weight of about 15,000 to about 50,000 g/mole. In yet another embodiment, the polycarbonate has a weight average molecular weight of about 20,000 to about 40,000 g/mole.

In addition to polycarbonates, copolyestercarbonates, or blends of polyesters with polycarbonates may also be advantageously used in the first and/or second sheet. The polyesters may be cycloaliphatic polyesters, polyarylates or a combination of cycloaliphatic polyesters with polyarylates.

Cycloaliphatic polyesters suitable for use in the first and second sheet are those that are characterized by improved weatherability, chemical resistance, and low water absorption. It is also generally desirable that the cycloaliphatic polyesters have good melt compatibility with other thermoplastic polymers used in the first and second sheet. In an exemplary embodiment, it is preferred to use a cycloaliphatic polyester that displays good melt compatibility with the polycarbonate used in the first and second sheets. Cycloaliphatic polyesters are generally prepared by reaction of a diol with a dibasic acid or derivative. The diols useful in the preparation of the cycloaliphatic polyester polymers for use as the high quality optical sheets are straight chain, branched, or cycloaliphatic, preferably straight chain or branched alkane diols, and may contain from 2 to 12 carbon atoms.

Suitable examples of diols include ethylene glycol, propylene glycol such as 1,2- and 1,3-propylene glycol, and the like; butane diol such as 1,3- and 1,4-butane diol, and the like; diethylene glycol, 2,2-dimethyl-1,3-propane diol, 2-ethyl, 2-methyl, 1,3-propane diol, 1,3- and 1,5-pentane diol, dipropylene glycol, 2-methyl-1,5-pentane diol, 1,6-hexane diol, 1,4-cyclohexane dimethanol and particularly its cis- and trans-isomers, triethylene glycol, 1,10-decane diol, and combinations comprising at least one of the foregoing diols. Particularly preferred is dimethanol bicyclo octane, dimethanol decalin, a cycloaliphatic diol or chemical equivalents thereof, and particularly 1,4-cyclohexane dimethanol or its chemical equivalents. If 1,4-cyclohexane dimethanol is to be used as the diol component, it is generally preferred to use a mixture of cis- to trans-isomes in ratios of about 1:4 to about 4:1. Within this range, it is generally desired to use a ratio of cis- to trans-isomers of about 1:3.

The diacids useful in the preparation of the cycloaliphatic polyester polymers are aliphatic diacids that include carboxylic acids having two carboxyl groups each of which are attached to a saturated carbon in a saturated ring. Suitable examples of cycloaliphatic acids include decahydro naphthalene dicarboxylic acid, norbornene dicarboxylic acids, bicyclo octane dicarboxylic acids. Preferred cycloaliphatic diacids are 1,4-cyclohexanedicarboxylic acid and trans-1,4-cyclohexanedicarboxylic acids. Linear aliphatic diacids are also useful provided the polyester has at least one monomer containing a cycloaliphatic ring. Illustrative examples of linear aliphatic diacids are succinic acid, adipic acid, dimethyl succinic acid, and azelaic acid. Mixtures of diacid and diols may also be used to make the cycloaliphatic polyesters.

Cyclohexanedicarboxylic acids and their chemical equivalents can be prepared, for example, by the hydrogenation of cycloaromatic diacids and corresponding derivatives such as isophthalic acid, terephthalic acid or naphthalenic acid in a suitable solvent (e.g., water or acetic acid) at room temperature and at atmospheric pressure using catalysts such as rhodium supported on a carrier comprising carbon and alumina. They may also be prepared by the use of an inert liquid medium wherein an acid is at least partially soluble under reaction conditions and a catalyst of palladium or ruthenium in carbon or silica is used.

Generally, during hydrogenation, two or more isomers are obtained in which the carboxylic acid groups are in cis- or trans-positions. The cis- and trans-isomers can be separated by crystallization with or without a solvent, for example, n-heptane, or by distillation. The cis-isomer tends to be more miscible, however, the trans-isomer has higher melting and crystallization temperatures and is especially preferred. Mixtures of the cis- and trans-isomers may also be used, and preferably when such a mixture is used, the trans-isomer will preferably comprise at least about 75 wt % and the cis-isomer will comprise the remainder based on the total weight of cis- and trans-isomers combined. When a mixture of isomers or more than one diacid is used, a copolyester or a mixture of two polyesters may be used as the cycloaliphatic polyester polymer.

Chemical equivalents of these diacids including esters may also be used in the preparation of the cycloaliphatic polyesters. Suitable examples of the chemical equivalents of the diacids are alkyl esters, e.g., dialkyl esters, diaryl esters, anhydrides, acid chlorides, acid bromides, or the like, or combinations comprising at least one of the foregoing chemical equivalents. The preferred chemical equivalents comprise the dialkyl esters of the cycloaliphatic diacids, and the most preferred chemical equivalent comprises the dimethyl ester of the acid, particularly dimethyl-trans-1,4-cyclohexanedicarboxylate.

Dimethyl-1,4-cyclohexanedicarboxylate can be obtained by ring hydrogenation of dimethylterephthalate, and two isomers having the carboxylic acid groups in the cis- and trans-positions are obtained. The isomers can be separated, the trans-isomer being especially preferred. Mixtures of the isomers may also be used as detailed above.

The polyester polymers are generally obtained through the condensation or ester interchange polymerization of the diol or diol chemical equivalent component with the diacid or diacid chemical equivalent component and having recurring units of the formula (X): 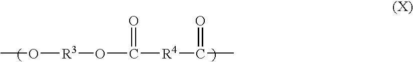
wherein R³ represents an alkyl or cycloalkyl radical containing 2 to 12 carbon atoms and which is the residue of a straight chain, branched, or cycloaliphatic alkane diol having 2 to 12 carbon atoms or chemical equivalents thereof; and R⁴ is an alkyl or a cycloaliphatic radical which is the decarboxylated residue derived from a diacid, with the proviso that at least one of R³ or R⁴ is a cycloalkyl group.

A preferred cycloaliphatic polyester is poly(1,4-cyclohexanedimethanol-1,4-cyclohexanedicarboxylate) (PCCD) having recurring units of formula (XI) 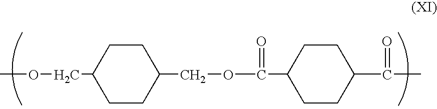
wherein in the formula (IX) R³ is a cyclohexane ring, and wherein R⁴ is a cyclohexane ring derived from cyclohexanedicarboxylate or a chemical equivalent thereof and is selected from the cis- or trans-isomer or a mixture of cis- and trans-isomers thereof. Cycloaliphatic polyester polymers can be generally made in the presence of a suitable catalyst such as a tetra(2-ethyl hexyl)titanate, in a suitable amount, generally about 50 to 400 ppm of titanium based upon the total weight of the final product.

PCCD is generally completely miscible with the polycarbonate. It is generally desirable for a polycarbonate-PCCD mixture to have a melt volume rate of greater than or equal to about 5 cubic centimeters/10 minutes (cc/10 min or ml/10 min) to less than or equal to about 150 cubic centimeters/10 minutes when measured at 265° C., at a load of 2.16 kilograms and a four minute dwell time. Within this range, it is generally desirable to have a melt volume rate of greater than or equal to about 7, preferably greater than or equal to about 9, and more preferably greater than or equal to about 10 cc/10 min when measured at 265° C., at a load of 2.16 kilograms and a four minute dwell time. Also desirable within this range, is a melt volume rate of less than or equal to about 125, preferably less than or equal to about 110, and more preferably less than or equal to about 100 cc/10 minutes.

Other preferred cycloaliphatic polyesters that may be mixed with the polycarbonate are polyethelene terephthalate (PET), polybutylene terephthalate (PBT), poly(trimethylene terephthalate) (PTT), poly(cyclohexanedimethanol-co-ethylene terephthalate) (PETG), poly(ethylene naphthalate) (PEN), and poly(butylene naphthalate) (PBN).

Another preferred polyester that may be used in the first and/or second sheet is a polyarylate. Polyarylates generally refers to polyesters of aromatic dicarboxylic acids and bisphenols. Polyarylate copolymers that include carbonate linkages in addition to the aryl ester linkages, are termed polyester-carbonates, and may also be advantageously utilized in the mixtures. The polyarylates can be prepared in solution or by the melt polymerization of aromatic dicarboxylic acids or their ester forming derivatives with bisphenols or their derivatives.

In general, it is preferred for the polyarylates to comprise at least one diphenol residue in combination with at least one aromatic dicarboxylic acid residue. The preferred diphenol residue, illustrated in formula (XII), is derived from a 1,3-dihydroxybenzene moiety, referred to throughout this specification as resorcinol or resorcinol moiety. Resorcinol or resorcinol moieties include both unsubstituted 1,3-dihydroxybenzene and substituted 1,3-dihydroxybenzenes.

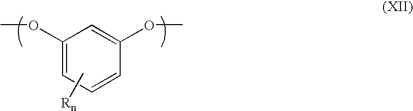

In formula (X), R is at least one of C₁₋₁₂ alkyl or halogen, and n is 0 to 3. Suitable dicarboxylic acid residues include aromatic dicarboxylic acid residues derived from monocyclic moieties, preferably isophthalic acid, terephthalic acid, or mixtures of isophthalic and terephthalic acids, or from polycyclic moieties such as diphenyl dicarboxylic acid, diphenylether dicarboxylic acid, and naphthalene-2,6-dicarboxylic acid, or the like, or combinations comprising at least one of the foregoing polycyclic moieties. The preferred polycyclic moiety is naphthalene-2,6-dicarboxylic acid.

Preferably, the aromatic dicarboxylic acid residues are derived from mixtures of isophthalic and/or terephthalic acids as generally illustrated in formula (XIII).

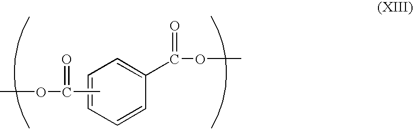

Therefore, in one embodiment the polyarylates comprise resorcinol arylate polyesters as illustrated in formula (XIV) wherein R and n are previously defined for formula (XI). 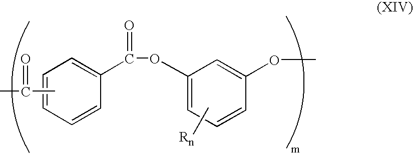
wherein R is at least one of C₁₋₁₂ alkyl or halogen, n is 0 to 3, and m is at least about 8. It is preferred for R to be hydrogen. Preferably, n is zero and m is about 10 and about 300. The molar ratio of isophthalate to terephthalate is about 0.25:1 to about 4.0:1.

In another embodiment, the polyarylate comprises thermally stable resorcinol arylate polyesters that have polycyclic aromatic radicals as shown in formula (XV) 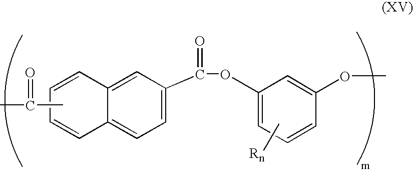
wherein R is at least one of C₁₋₁₂ alkyl or halogen, n is 0 to 3, and m is at least about 8.

In another embodiment, the polyarylates are copolymerized to form block copolyestercarbonates, which comprise carbonate and arylate blocks. They include polymers comprising structural units of the formula (XVI) 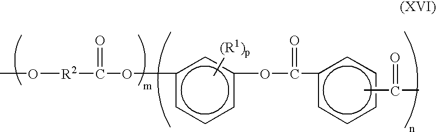
wherein each R¹ is independently halogen or C₁₋₁₂ alkyl, m is at least 1, p is about 0 to about 3, each R² is independently a divalent thermoplastic radical, and n is at least about 4. Preferably n is at least about 10, more preferably at least about 20 and most preferably about 30 to about 150. Preferably m is at least about 3, more preferably at least about 10 and most preferably about 20 to about 200. In an exemplary embodiment m is present in an amount of about 20 and 50.

It is generally desirable for the weight average molecular weight of the polyester to be about 500 to about 1,000,000 grams/mole (g/mole). In one embodiment, the polyester has a weight average molecular weight of about 10,000 to about 200,000 g/mole. In another embodiment, the polyester has a weight average molecular weight of about 15,000 to about 150,000 g/mole. In yet another embodiment, the polyester has a weight average molecular weight of about 20,000 to about 120,000 g/mole. An exemplary molecular weight for a cycloaliphatic polyester utilized in the multiwall sheet is about 60,000 to about 120,000 g/mole. An exemplary molecular weight for a polyarylate polyester utilized in the multiwall sheet is about 20,000 to about 35,000 g/mole. The polyester molecular weights are determined against a polystyrene standard.

When the multiwall sheet consists of only a first sheet and a second sheet with the associated ribs, the thermoplastic polymers are generally used in amounts of about 50 to about 99 weight percent (wt %) based upon the weight of the multiwall sheet. In one embodiment, the thermoplastic polymer may be used in an amount of about 70 to about 98 wt %, based on the total weight of the multiwall sheet. In another embodiment, the thermoplastic polymer may be used in an amount of about 80 to about 95 wt %, based on the total weight of the multiwall sheet. In yet another embodiment, the thermoplastic polymer may be used in an amount of about 82 to about 90 wt %, based on the total weight of the multiwall sheet.

The electrically conductive fillers that may be used to impart electrical conductivity to the thermoplastic resin used in the first and second sheet are carbonaceous conductive fillers such as carbon black, coke, carbon nanotubes, carbon buckeye balls, and the like; metallic conductive fillers, non-metallic conductive fillers, non-conductive fillers coated with metals, or the like, or combinations comprising at least one of the foregoing fillers.

Carbon black may also be optionally used in the multiwall sheets. Preferred carbon blacks are those having average particle sizes less than about 200 nm, preferably less than about 100 nm, more preferably less than about 50 nm. Preferred conductive carbon blacks may also have surface areas greater than about 200 square meter per gram (m²/g), preferably greater than about 400 m²/g, yet more preferably greater than about 1000 m²/g. Preferred conductive carbon blacks may have a pore volume (dibutyl phthalate absorption) greater than about 40 cubic centimeters per hundred grams (cm³/100 g), preferably greater than about 100 cm³/100 g, more preferably greater than about 150 cm³/100 g. Exemplary carbon blacks include the carbon black commercially available from Columbian Chemicals under the trade name CONDUCTEX; the acetylene black available from Chevron Chemical, under the trade names S.C.F. (Super Conductive Furnace) and E.C.F. (Electric Conductive Furnace); the carbon blacks available from Cabot Corp. under the trade names VULCAN XC72 and BLACK PEARLS; and the carbon blacks commercially available from Akzo Co. Ltd under the trade names KETJEN BLACK EC 300 and EC 600.

Conductive carbon blacks may be used in amounts from about 2 wt % to about 25 wt % based on the total weight of the multiwall sheet. In one embodiment, conductive carbon blacks may be used in amounts from about 2 wt % to about 25 wt % based on the total weight of the multiwall sheet. In another embodiment, conductive carbon blacks may be used in amounts from about 4 wt % to about 22 wt %, based on the total weight of the multiwall sheet. In yet another embodiment, conductive carbon blacks may be used in amounts from about 6 wt % to about 15 wt %, based on the total weight of the multiwall sheet.

Carbon nanotubes may also be used in the multiwall conductive sheets. The carbon nanotubes may be single wall carbon nanotubes (SWNT), multiwall carbon nanotubes (MWNT) or vapor grown carbon fibers (VGCF). SWNTs used in the multiwall sheet may be produced by laser-evaporation of graphite, carbon arc synthesis or the high-pressure carbon monoxide conversion process (HIPCO) process. These SWNTs generally have a single wall comprising a graphene sheet with outer diameters of about 0.7 to about 2.4 nanometers (nm). SWNTs having aspect ratios of greater than or equal to about 5, preferably greater than or equal to about 100, more preferably greater than or equal to about 1000 are generally utilized in the multiwall sheets. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In an exemplary embodiment, the purpose of dispersion of the SWNTs in the thermoplastic polymer is to disentangle the SWNTs so as to obtain an effective aspect ratio that is as close to the aspect ratio of the SWNT as possible. The ratio of the effective aspect ratio to the aspect ratio is a measure of the effectiveness of dispersion. The effective aspect ratio is a value that is twice the radius of gyration of a single SWNT divided by the outer diameter of the respective individual nanotube. It is generally desirable for the average value of ratio of the effective aspect ratio to the aspect ratio to be greater than or equal to about 0.5, preferably greater than or equal to about 0.75, and more preferably greater than or equal to about 0.90, as measured in a electron micrograph at a magnification of greater than or equal to about 10,000.

In one embodiment, the SWNTs may exist in the form of rope-like-aggregates. These aggregates are commonly termed “ropes” and are formed as a result of Van der Waal's forces between the individual SWNTs. The individual nanotubes in the ropes may slide against one another and rearrange themselves within the rope in order to minimize the free energy. Ropes generally having between 10 and 10⁵ nanotubes may be used in the multiwall sheets. Within this range, it is generally desirable to have ropes having greater than or equal to about 100, preferably greater than or equal to about 500 nanotubes. Also desirable, are ropes having less than or equal to about 10⁴ nanotubes, preferably less than or equal to about 5,000 nanotubes.

In yet another embodiment, it is desirable for the SWNT ropes to connect each other in the form of branches after dispersion. This results in a sharing of the ropes between the branches of the SWNT networks to form a 3-diminsional network in the thermoplastic polymer. A distance of about 10 nm to about 10 micrometers may separate the branching points in this type of network. It is generally desirable for the SWNTs to have an inherent thermal conductivity of at least 2000 Watts per meter Kelvin (W/m-K) and for the SWNT ropes to have an inherent electrical conductivity of 10⁴ Siemens/centimeter (S/cm). It is also generally desirable for the SWNTs to have a tensile strength of at least 80 gigapascals (GPa) and a stiffness of at least about 0.5 terapascals (TPa).

In another embodiment, the SWNTs may comprise a mixture of metallic nanotubes and semi-conducting nanotubes. Metallic nanotubes are those that display electrical characteristics similar to metals, while the semi-conducting nanotubes are those, which are electrically semi-conducting. In general the manner in which the graphene sheet is rolled up produces nanotubes of various helical structures. Zigzag and armchair nanotubes constitute two possible confirmations. In order to minimize the quantity of SWNTs utilized in the multiwall sheet, it is generally desirable to have the multiwall sheet comprise as large a fraction of metallic SWNTs. It is generally desirable for the SWNTs used in the multiwall sheet to comprise metallic nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs. In certain situations, it is generally desirable for the SWNTs used in the multiwall sheet to comprise semi-conducting nanotubes in an amount of greater than or equal to about 1 wt %, preferably greater than or equal to about 20 wt %, more preferably greater than or equal to about 30 wt %, even more preferably greater than or equal to about 50 wt %, and most preferably greater than or equal to about 99.9 wt % of the total weight of the SWNTs.

SWNTs are generally used in amounts of about 0.001 to about 80 wt % of the total weight of the multiwall sheet when desirable. In one embodiment, SWNTs may be used in amounts from about 0.25 wt % to about 30 wt % based on the total weight of the multiwall sheet. In another embodiment, SWNTs may be used in amounts from about 0.5 wt % to about 10 wt %, based on the total weight of the multiwall sheet. In yet another embodiment, SWNTs may be used in amounts from about 1 wt % to about 5 wt %, based on the total weight of the multiwall sheet.

In one embodiment, the SWNTs may contain production related impurities. Production related impurities present in SWNTs as defined herein are those impurities, which are produced during processes substantially related to the production of SWNTs. As stated above, SWNTs are produced in processes such as, for example, laser ablation, chemical vapor deposition, carbon arc, high-pressure carbon monoxide conversion processes, or the like. Production related impurities are those impurities that are either formed naturally or formed deliberately during the production of SWNTs in the aforementioned processes or similar manufacturing processes. A suitable example of a production related impurity that is formed naturally are catalyst particles used in the production of the SWNTs. A suitable example of a production related impurity that is formed deliberately is a dangling bond formed on the surface of the SWNT by the deliberate addition of a small amount of an oxidizing agent during the manufacturing process.

Production related impurities include for example, carbonaceous reaction by-products such as defective SWNTs, multiwall carbon nanotubes, branched or coiled multiwall carbon nanotubes, amorphous carbon, soot, nano-onions, nanohorns, coke, or the like; catalytic residues from the catalysts utilized in the production process such as metals, metal oxides, metal carbides, metal nitrides or the like, or combinations comprising at least one of the foregoing reaction byproducts. A process that is substantially related to the production of SWNTs is one in which the fraction of SWNTs is larger when compared with any other fraction of production related impurities. In order for a process to be substantially related to the production of SWNTs, the fraction of SWNTs would have to be greater than a fraction of any one of the above listed reaction byproducts or catalytic residues. For example, the fraction of SWNTs would have to be greater than the fraction of multiwall nanotubes, or the fraction of soot, or the fraction of carbon black. The fraction of SWNTs would not have to be greater than the sums of the fractions of any combination of production related impurities for the process to be considered substantially directed to the production of SWNTs.

In general, the SWNTs used in the multiwall sheet may comprise an amount of about 0.1 to about 80 wt % impurities. In one embodiment, the impurities may be present in amounts from about 3 wt % to about 50 wt %, based on the total weight of the SWNTs. In another embodiment, the impurities may be present in amounts from about 7 wt % to about 45 wt %, based on the total weight of the SWNTs. In yet another embodiment, the impurities may be present in amounts from about 8 wt % to about 40 wt %, based on the total weight of the SWNTs.

In one embodiment, the SWNTs used in the multiwall sheet may comprise an amount of about 0.1 to about 50 wt % catalytic residues. In one embodiment, the catalytic residues may be present in amounts from about 1 wt % to about 30 wt %, based on the total weight of the SWNTs. In another embodiment, the catalytic residues may be present in amounts from about 3 wt % to about 25 wt %, based on the total weight of the SWNTs. In yet another embodiment, the catalytic residues may be present in amounts from about 5 wt % to about 20 wt %, based on the total weight of the SWNTs.

Other carbon nanotubes such as multiwall carbon nanotubes (MWNTs) and VGCF may also be added to the multiwall sheets during the polymerization of the polymeric precursor. The MWNTs and VGCF that are added to the multiwall sheet are not considered impurities since these are not produced during the production of the SWNTs. MWNTs derived from processes such as laser ablation and carbon arc synthesis, which is not directed at the production of SWNTs, may also be used in the multiwall sheets. MWNTs have at least two graphene layers bound around an inner hollow core. Hemispherical caps generally close both ends of the MWNTs, but it may desirable to use MWNTs having only one hemispherical cap or MWNTs, which are devoid of both caps. MWNTs generally have diameters of about 2 to about 50 nm. Within this range, it is generally desirable to use MWNTs having diameters less than or equal to about 40, preferably less than or equal to about 30, and more preferably less than or equal to about 20 nm. When MWNTs are used, it is preferred to have an average aspect ratio greater than or equal to about 5, preferably greater than or equal to about 100, more preferably greater than or equal to about 1000.

MWNTs are generally used in amounts of about 0.001 to about 50 wt % of the total weight of the multiwall sheet. In one embodiment, MWNTs may be used in amounts from about 0.25 wt % to about 30 wt % based on the total weight of the multiwall sheet. In another embodiment, MWNTs may be used in amounts from about 0.5 wt % to about 10 wt %, based on the total weight of the multiwall sheet. In yet another embodiment, MWNTs may be used in amounts from about 1 wt % to about 5 wt %, based on the total weight of the multiwall sheet.

Vapor grown carbon fibers or small graphitic or partially graphitic carbon fibers, also referred to as vapor grown carbon fibers (VGCF), having diameters of about 3.5 to about 2000 nanometers (nm) and an aspect ratio greater than or equal to about 5 may also be used. In one embodiment, VGCF having diameters of about 3.5 to about 100 run may be used. In one embodiment, VGCF having diameters of about 3.5 to about 50 nm may be used. In one embodiment, VGCF having diameters of about 3.5 to about 20 nm may be used. It is also preferable to use VGCF having average aspect ratios greater than or equal to about 100 and more preferably greater than or equal to about 1000.

VGCF are generally used in amounts of about 0.001 to about 50 wt % of the total weight of the multiwall sheet. In one embodiment, VGCF may be used in amounts from about 0.25 wt % to about 30 wt % based on the total weight of the multiwall sheet. In another embodiment, MWNTs may be used in amounts from about 0.5 wt % to about 10 wt %, based on the total weight of the multiwall sheet. In yet another embodiment, MWNTs may be used in amounts from about 1 wt % to about 5 wt %, based on the total weight of the multiwall sheet.

Both the SWNTs and the other carbon nanotubes (MWNTs and VGCF) utilized in the multiwall sheet may also be derivatized with functional groups to improve compatibility and facilitate the mixing with the thermoplastic polymer. The SWNTs and the other carbon nanotubes may be functionalized on either the graphene sheet constituting the sidewall, a hemispherical cap or on both the side wall as well as the hemispherical endcap. Functionalized SWNTs and the other carbon nanotubes are those having the formula (XVII)
[CₙH_{L}Rₘ (XVII)
wherein n is an integer, L is a number less than 0.1 n, m is a number less than 0.5 n, and wherein each of R is the same and is selected from —SO₃H, —NH₂, —OH, —C(OH)R′, —CHO, —CN, —C(O)Cl, —C(O)SH, —C(O)OR′, —SR′, —SiR₃′, —Si(OR′)_{y}R′_{(3-y)}, -R″, —AlR₂′, halide, ethylenically unsaturated functionalities, epoxide functionalities, or the like, wherein y is an integer equal to or less than 3, R′ is hydrogen, alkyl, aryl, cycloalkyl, araalkyl, cycloaryl, poly(alkylether), or the like and R″ is fluoroalkyl, fluoroaryl, fluorocycloalkyl, fluoroaralkyl, cycloaryl, or the like. The carbon atoms, Cₙ, are surface carbons of a carbon nanotube. In both, uniformly and non-uniformly substituted SWNTs and other carbon nanotubes, the surface atoms Cₙ are reacted.

Non-uniformly substituted SWNTs and other carbon nanotubes may also be used in the multiwall sheet. These include multiwall sheets of the formula (I) shown above wherein n, L, m, R and the SWNT itself are as defined above, provided that each of R does not contain oxygen, or, if each of R is an oxygen-containing group, COOH is not present.

Also included are functionalized SWNTs and other carbon nanotubes having the formula (XVIII)
[CₙH_{L}R″-R]ₘ (XVIII)
where n, L, m, R′ and R have the same meaning as above. Most carbon atoms in the surface layer of a carbon nanotube are basal plane carbons. Basal plane carbons are relatively inert to chemical attack. At defect sites, where, for example, the graphitic plane fails to extend fully around the carbon nanotube, there are carbon atoms analogous to the edge carbon atoms of a graphite plane. The edge carbons are reactive and must contain some heteroatom or group to satisfy carbon valency.

The substituted SWNTs and other carbon nanotubes described above may advantageously be further functionalized. Such multiwall sheets include multiwall sheets of the formula (XIX)
[CₙH_{L}Aₘ (XIX)
where n, L and m are as described above, A is selected from —OY, —NHY, —CR′₂—OY, —C(O)OY, —C(O)NR′Y, —C(O)SY, or —C(O)Y, wherein Y is an appropriate functional group of a protein, a peptide, an enzyme, an antibody, a nucleotide, an oligonucleotide, an antigen, or an enzyme substrate, enzyme inhibitor or the transition state analog of an enzyme substrate or is selected from -R′OH, -R′NH₂, -R′SH, —R′CHO, -R′CN, -R′X, -R′SiR′₃, -RSi—(OR′)_{y}-R_{(3-y)}, -R′ Si—(O—SiR′₂)—OR′, -R′-R″, -R′—NCO, (C₂H₄O)_{w}Y, —(C₃H₆O)_{w}H, —(C₂H₄O)_{w}R′, —(C₃H₆O)_{w}R′ and R″, wherein w is an integer greater than one and less than 200.

The functional SWNTs and other carbon nanotubes of structure (XVIII) may also be functionalized to produce multiwall sheets having the formula (XX)
[CₙH_{L}R′-A]ₘ (XX)
where n, L, m, R′ and A are as defined above.

The multiwall sheets also include SWNTs and other carbon nanotubes upon which certain cyclic compounds are adsorbed. These include multiwall sheets of matter of the formula (XXI)
[CₙH_{L}X-Rₐ]ₘ (XXI)
where n is an integer, L is a number less than 0.1 n, m is less than 0.5 n, a is zero or a number less than 10, X is a polynuclear aromatic, polyheteronuclear aromatic or metallopolyheteronuclear aromatic moiety and R is as recited above. Preferred cyclic compounds are planar macrocycles such as re porphyrins and phthalocyanines.

The adsorbed cyclic compounds may be functionalized. Such multiwall sheets include compounds of the formula (XXII)
[CₙH_{L}X-Aₐ]ₘ (XXII)
where m, n, L, a, X and A are as defined above and the carbons are on the SWNT or on other nanotubes such as MWNTs, VGCF, or the like.

Without being bound to a particular theory, the functionalized SWNTs and other carbon nanotubes are better dispersed into thermoplastic polymers because the modified surface properties may render the carbon nanotube more compatible with the thermoplastic polymer, or, because the modified functional groups (particularly hydroxyl or amine groups) are bonded directly to the thermoplastic polymer as terminal groups. In this way, thermoplastic polymers such as polycarbonates, polyamides, polyesters, polyetherimides, or the like, bond directly to the carbon nanotubes, thus making the carbon nanotubes easier to disperse with improved adherence to the thermoplastic polymer.

Functional groups may generally be introduced onto the outer surface of the SWNTs and the other carbon nanotubes by contacting the respective outer surfaces with a strong oxidizing agent for a period of time sufficient to oxidize the surface of the SWNTs and other carbon nanotubes and further contacting the respective outer surfaces with a reactant suitable for adding a functional group to the oxidized surface. Preferred oxidizing agents are comprised of a solution of an alkali metal chlorate in a strong acid. Preferred alkali metal chlorates are sodium chlorate or potassium chlorate. A preferred strong acid used is sulfuric acid. Periods of time sufficient for oxidation are about 0.5 hours to about 24 hours.

Solid conductive metallic fillers may also be used in the conductive multiwall sheets. These may be electrically conductive metals or alloys that do not melt under conditions used in incorporating them into the thermoplastic polymer, and fabricating finished articles therefrom. Metals such as aluminum, copper, magnesium, chromium, tin, nickel, silver, iron, titanium, and mixtures comprising any one of the foregoing metals can be incorporated into the thermoplastic polymer as conductive fillers. Physical mixtures and true alloys such as stainless steels, bronzes, and the like, may also serve as conductive filler particles. In addition, a few intermetallic chemical compounds such as borides, carbides, and the like, of these metals, (e.g., titanium diboride) may also serve as conductive filler particles. Solid non-metallic, conductive filler particles such as tin oxide, indium tin oxide, antimony tin oxide, and the like may also be added to render the thermoplastic polymer conductive. The solid metallic and non-metallic conductive fillers may exist in the form of powder, drawn wires, strands, fibers, tubes, nanotubes, flakes, laminates, platelets, ellipsoids, discs, and other commercially available geometries.

Non-conductive, non-metallic fillers that have been coated over a substantial portion of their surface with a coherent layer of solid conductive metal may also optionally be used in the conductive multiwall sheets. The non-conductive, non-metallic fillers are commonly referred to as substrates, and substrates coated with a layer of solid conductive metal may be referred to as “metal coated fillers”. Typical conductive metals such as aluminum, copper, magnesium, chromium, tin, nickel, silver, iron, titanium, and mixtures comprising any one of the foregoing metals may be used to coat the substrates. Examples of such substrates include silica powder, such as fused silica and crystalline silica, boron-nitride powder, boron-silicate powders, alumina, magnesium oxide (or magnesia), wollastonite, including surface-treated wollastonite, calcium sulfate (as its anhydride, dihydrate or trihydrate), calcium carbonate, including chalk, limestone, marble and synthetic, precipitated calcium carbonates, generally in the form of a ground particulates, talc, including fibrous, modular, needle shaped, and lamellar talc, glass spheres, both hollow and solid, kaolin, including hard, soft, calcined kaolin, and kaolin comprising various coatings to facilitate compatibility with the polymeric matrix polymer, mica, feldspar, silicate spheres, flue dust, cenospheres, fillite, aluminosilicate (armospheres), natural silica sand, quartz, quartzite, perlite, tripoli, diatomaceous earth, synthetic silica, and mixtures comprising any one of the foregoing. All of the above substrates may be coated with a layer of metallic material for use in the conductive multiwall sheets.

Regardless of the exact size and shape of the solid metallic and non-metallic conductive filler particles, they may be dispersed into the thermoplastic polymer at loadings of about 0.001 to about 50 wt %, based on the total weight of the multiwall sheet. In one embodiment, the solid metallic and non-metallic conductive filler particles may be present in amounts from about 3 wt % to about 45 wt %, based on the total weight of the multiwall sheet. In another embodiment, the solid metallic and non-metallic conductive filler particles may be present in amounts from about 5 wt % to about 40 wt %, based on the total weight of the multiwall sheet. In yet another embodiment, the solid metallic and non-metallic conductive filler particles may be present in amounts from about 10 wt % to about 35 wt %, based on the total weight of the multiwall sheet.

In one embodiment, when a blend of thermoplastic polymers is used to form the first and second sheet of the multiwall sheet, the electrically conductive fillers may be added to only a single phase of the blend. It is generally desirable for the electrically conductive fillers to be added to the continuous phase of the blend.

Other additives such as antioxidants, flame retardants, anti-drip agents, anti-ozonants, thermal stabilizers, anti-corrosion additives, impact modifiers, ultra violet (UV) absorbers, mold release agents, fillers, anti-static agents, flow promoters, pigments, dyes, and the like, commonly used in thermoplastic compositions may also be added in the amounts desired.

Suitable thermal stabilizers include phosphites, phosphonites, phosphines, hindered amines, hydroxylamines, phenols, acryloyl modified phenols, hydroperoxide decomposers, benzofuranone derivatives, or the like, or combinations comprising at least one of the foregoing thermal stabilizers. Suitable thermal stabilizers that are commercially available are IRGAPHOS 168, DOVERPHOS S-9228, or ULTRANOX 641. If desirable, an optional co-stabilizer such as a cyclo aliphatic epoxy polymer or IRGANOX 1076 may also be added to improve thermal stability of the multiwall sheet. The preferred thermal stabilizers are phosphites.

It is generally desirable to add the thermal stabilizer in an amount of about 0.001 to about 3 wt %, based on the total weight of the multiwall sheet. In one embodiment, the thermal stabilizer may be added in amounts of about 0.002 to about 0.5 wt %, based on the total weight of the multiwall sheet. In another embodiment, the thermal stabilizer may be added in amounts of about 0.005 to about 0.2 wt %, based on the total weight of the multiwall sheet. In yet another embodiment, the thermal stabilizer may be added in amounts of about 0.01 to about 0.1 wt %, based on the total weight of the multiwall sheet. If a co-stabilizer is added, it is generally desirable to add it in amount of about 0.001 to about 2 wt %, based on the total weight of the multiwall sheet.

Antistatic agents may optionally be added to the thermoplastic polymers used to manufacture the multiwall sheets. The term “antistatic agent” refers to several materials that can be either melt-processed into polymeric resins or sprayed onto commercially available polymeric forms and shapes to improve conductive properties and overall physical performance. Examples of monomeric antistatic agents that may be used are glycerol monostearate, glycerol distearate, substituted phosphonium salts of medium and short chain halogenated fluorocarbon sulfonic acids, glycerol tristearate, ethoxylated amines, primary, secondary and tertiary amines, ethoxylated alcohols, alkyl sulfates, alkylarylsulfates, alkylphosphates, alkylaminesulfates, quaternary ammonium salts, quaternary ammonium resins, imidazoline derivatives, sorbitan esters, ethanolamides, betaines, or the like, or combinations comprising at least one of the foregoing monomeric antistatic agents. Suitable examples of commercial monomeric antistatic agents which may be used in polymeric resins are PATIONIC 1042 and PATIONIC AS10 available from Patco or STATEXAN K1 available from Bayer.

The phosphonium sulfonate is preferably fluorinated phosphonium sulfonate and is composed of a fluorocarbon containing an organic sulfonate anion and an organic phosphonium cation. Suitable examples of substituted phosphonium salts of medium and short chain halogenated fluorocarbon sulfonic acids are perfluoro methane sulfonate, perfluoro butane sulfonate, perfluoro hexane sulfonate, perfluoro heptane sulfonate and perfluoro octane sulfonate. Examples of the aforementioned phosphonium cation include aliphatic phosphonium such as tetramethyl phosphonium, tetraethyl phosphonium, tetrabutyl phosphonium, triethylmethyl phosphonium, tributylmethyl phosphonium, tributylethyl phosphonium, trioctylmethyl phosphonium, trimethylbutyl phosphonium trimethyloctyl phosphonium, trimethyllauryl phosphonium, trimethylstearyl phosphonium, triethyloctyl phosphonium and aromatic phosphoniums such as tetraphenyl phosphonium, triphenylmethyl phosphonium, triphenylbenzyl phosphonium, tributylbenzyl phosphonium.

Suitable examples of monomeric ammonium antistatic salts are octyldimethyl-2-hydroxyethylammonium bis(trifluoromethylsulfonyl)imide, octyldimethyl-2-hydroxyethylammonium perfluorobutanesulfonate, octyldimethyl-2-hydroxyethylammonium trifluoromethanesulfonate, triethylammonium bis(perfluoroethanesulfonyl)imide, tetraethylammonium trifluoromethanesulfonate, trimethyl-3-perfluorooctylsulfonamidopropylammonium bis(trifluoromethanesulfonyl)imide, 1,3-ethylmethylimidazolium nonafluorobutanesulfonate, 1,3-ethylmethylimidazolium bis(trifluoromethanesulfonyl)iniide, 1,3-ethylmethylimidazolium trifluoromethanesulfonate, tetrabutylphosphonium perfluorobutanesulfonate, or the like, or a combination comprising at least one of the foregoing monomeric ammonium antistatic salts. Most preferred ionic salt monomeric antistatic agents include octyldimethyl-2-hydroxyethylammonium bis(trifluoromethylsulfonyl)imide, octyldimethyl-2-hydroxyethylammonium trifluoromethanesulfonate, octyldimethyl-2-hydroxyethylammonium nonafluorobutanesulfonate, triethylammonium bis(perfluoroethanesulfonyl)imide, 1,3-ethylmethylimidazolium nonafluorobutanesulfonate, 1,3-ethylmethylimidazolium bis(trifluoromethanesulfonyl)imide, 1,3-ethylmethylimidazolium trifluoromethanesulfonate, tetrabutylphosphonium perfluorobutanesulfonate or the like, or a combination comprising at least one of the foregoing monomeric antistatic agents.

Suitable examples of polymeric antistatic agents are the copolyesteramides, polyether-polyamide block copolymers, polyetheresteramide block copolymers, polyurethane containing a polyalkylene glycol moiety, or the like, or combinations comprising at least one of the foregoing polymeric antistatic agents. Polymeric antistatic agents have been shown to be fairly thermally stable and readily processable in the melt state in their neat form or in blends with other polymeric resins. Most of the known, inherently conducting polymers such as polyaniline, polypyrrole and polythiophene, which retain some of their intrinsic conductivity after melt processing at elevated temperatures, can also be used. Polymeric antistatic agents such as PELESTAT 6321 commercially available from Sanyo or HOSTASTAT commercially available from Clariant are examples of polymeric antistatic agents that may be added to the thermoplastic polymers to improve conductive properties. Without being limited by theory, the use of antistatic agents in conjunction with the conductive fillers minimizes any localized residual voltage present on the surface of the multiwall sheet. In one embodiment, when antistatic agents are used in conjunction with the conductive fillers, it is generally desirable for the multiwall sheet to have a residual voltage of less than or equal to about 10 volts 30 seconds after the charge is applied. In one embodiment, when antistatic agents are used in conjunction with the conductive fillers, it is generally desirable for the multiwall sheet to have a residual voltage of less than or equal to about 5 volts 30 seconds after the charge is applied. In yet one embodiment, when antistatic agents are used in conjunction with the conductive fillers, it is generally desirable for the multiwall sheet to have a residual voltage of less than or equal to about 1 volts 30 seconds after the charge is applied.

In one embodiment, monomeric antistatic agents, polymeric antistatic agents, inherently conductive polymers, or mixtures comprising at least one of the foregoing may be used in the multiwall sheets. The preferred antistatic agents are the monomeric and/or the polymeric antistatic agents. Chemical antistatic agents are generally used in amounts of about 0.001 to about 25 wt %, based on the total weight of the multiwall sheet. In one embodiment, the chemical antistatic agents are used in amounts of about 0.1 to about 20 wt %, based on the total weight of the multiwall sheet. In one embodiment, the chemical antistatic agents are used in amounts of about 0.5 to about 15 wt %, based on the total weight of the multiwall sheet. In one embodiment, the chemical antistatic agents are used in amounts of about 1.0 to about 10 wt %, based on the total weight of the multiwall sheet.

The multiwall sheet generally comprises a suitable UV absorber. Suitable UV absorbers are benzophenones such as 2,4 dihydroxybenzophenone, 2-hydroxy-4-methoxybenzophenone, 2-hydroxy-4-n-octoxybenzophenone, 4-dodecyloxy-2 hydroxybenzophenone, 2-hydroxy-4-octadecyloxybenzophenone, 2,2′ dihydroxy-4 methoxybenzophenone, 2,2′ dihydroxy-4,4′dimethoxybenzophenone, 2,2′ dihydroxy-4 methoxybenzophenone, 2,2′, 4,4′ tetra hydroxybenzophenone, 2-hydroxy-4-methoxy-5 sulfobenzophenone, 2-hydroxy-4-methoxy-2′-carboxybenzophenone, 2,2′dihydroxy-4,4′dimethoxy-5 sulfobenzophenone, 2-hydroxy-4-(2-hydroxy-3-methylaryloxy)propoxybenzophenone, 2-hydroxy-4 chlorobenzopheone, or the like; benzotriazoles such as 2,2′-(hydroxy-5-methyl phenyl)benzotriazole, 2,2′-(hydroxy-3′,5′-ditert-butyl phenyl)benzotriazole, and 2,2′-(hydroxy-X-tert, butyl-5′-methyl-phenyl)benzotriazole, or the like; salicylates such as phenyl salicylate, carboxyphenyl salicylate, p-octylphenyl salicylate, strontium salicylate, p-tert butylphenyl salicylate, methyl salicylate, dodecyl salicylate, or the like; and also other ultraviolet absorbents such as resorcinol monobenzoate, 2′ethyl hexyl-2-cyano, 3-phenylcinnamate, 2-ethyl-hexyl-2-cyano-3,3-diphenyl acrylate, ethyl-2-cyano-3,3-diphenyl acrylate, [2-2′-thiobis(4-t-octylphenolate)-1-n-butylamine, or the like, or combinations comprising at least one of the foregoing UV absorbers. A preferred UV absorber for use in the cap layer is UVINUL 3030, commercially available from BASF or Benzotriazole LA31 commercially available from Amfine Chemicals.

The UV absorbers are generally used in amounts of about 0.2 wt % to about 15 wt %, based upon the total weight of the multiwall sheet. In one embodiment, the UV absorber may be used in an amount of about 2 to about 14 wt %, based on the total weight of the multiwall sheet. In yet another embodiment, the UV absorber may be used in an amount of about 6 to about 12 wt %, based on the total weight of the cap layer. In one embodiment, the UV absorber may be used in an amount of about 9 to about 11 wt %, based on the total weight of the multiwall sheet.

Other additives that may be added to the multiwall sheet are impact modifiers. Suitable impact modifiers include natural and synthetic elastomeric polymers, typically derived from such monomers as olefins (e.g., ethylene, propylene, 1-butene and 4-methyl-1-pentene), alkenylaromatic monomers (e.g., styrene and α-methylstyrene), conjugated dienes (e.g., butadiene, isoprene and chloroprene), and vinylic carboxylic acids and their derivatives (e.g., vinyl acetate, acrylic acid, alkylacrylic acids, ethyl acrylate, methyl methacrylate and acrylonitrile). They include homopolymers and random, block, radial block, graft and core-shell copolymers as well as combinations thereof.

A particularly useful class of impact modifiers comprises the AB (diblock) and ABA (triblock) copolymers and core-shell graft copolymers of alkenylaromatic and diene compounds, especially those comprising styrene and either butadiene or isoprene blocks. The conjugated diene blocks may be partially or entirely hydrogenated, whereupon they may be represented as ethylene-propylene blocks and the like and have properties similar to those of olefin block copolymers. Examples of triblock copolymers of this type are polystyrene-polybutadiene-polystyrene (SBS), hydrogenated polystyrene-polybutadiene-polystyrene (SEBS), polystyrene-polyisoprene-polystyrene (SIS), poly(α-methylstyrene)-polybutadiene-poly(α-methylstyrene) and poly(α-methylstyrene)-polyisoprene-poly(α-methylstyrene). Particularly preferred triblock copolymers are available commercially as CARIFLEX, KRATON D, and KRATON G from Shell.

Also suitable as impact modifiers are core-shell type graft copolymers and ionomer resins, which may be wholly or partially neutralized with metal ions. In general, the core-shell type graft copolymers have a predominantly conjugated diene or crosslinked acrylate rubbery core and one or more shells polymerized thereon and derived from monoalkenylaromatic and/or acrylic monomers alone or in combination with other vinyl monomers. Other impact modifiers include the above-described types containing units having polar groups or active functional groups, as well as miscellaneous polymers such as Thiokol rubber, polysulfide rubber, polyurethane rubber, polyether rubber (e.g., polypropylene oxide), epichlorohydrin rubber, ethylene-propylene rubber, thermoplastic polyester elastomers, thermoplastic ether-ester elastomers, and the like, as well as mixtures comprising any one of the foregoing. Specially preferred amongst the ionomer resins is SURLYN available from Du Pont.

Impact modifiers may be used in amounts of about 0.5 to about 20 wt %, based on the total weight of the multiwall sheet. In one embodiment, the multiwall sheet may contain about 1 to about 15 wt % of impact modifier, based on the total weight of the multiwall sheet. In another embodiment, the multiwall sheet may contain about 2 to about 12 wt % of impact modifier, based on the total weight of the multiwall sheet. In yet another embodiment, the multiwall sheet may contain about 3 to about 8 wt % of impact modifier, based on the total weight of the multiwall sheet.

In addition, the multiwall sheet may include additional ingredients consistent with standard practices in the art. The multiwall sheet may include additional fibers such as glass fibers, mica, and the like. Minor amounts of other materials can also be included to modify specific properties of the multiwall sheet. For example, polytetrafluoroethylene (PTFE) in amounts of up to about 1 wt %, based on the total weight of the multiwall sheet, could be included as part of a flame retardant package. Other types of flame retardant packages including brominated flame retardant polymers (e.g. brominated PC) or phosphorus-containing organic flame retardants (such as resorcinol diphosphate, bisphenol A diphosphate or tetraxylyl piperazine diphosphamide) can also be included in effective amounts up to about 20 wt %, based on the total weight of the multiwall sheet. PTFE can also be included in larger amounts, up to about 25 wt %, to improve wear resistance; and polyethylene or polyethylene propylene glycol can be included in amounts up to about 2 wt %, based on the total weight of the multiwall sheet, to improve mold release characteristics. Flow promoters such as hydrogenated polyterpene can also be included in amounts up to about 10 wt %, based on the total weight of the multiwall sheet. Appropriate stabilizers and antioxidants can also be included. All of the above mentioned additives have their percent weights based on total resin composition.

The multiwall sheet may be manufactured by a variety of different methods that are employed in the process of manufacturing polymeric articles. The thermoplastic polymer along with the electrically conductive fillers are generally melt blended to form an electrically conductive composition. The electrically conductive composition may be formed in a single step or in multiple steps as desired. The electrically conductive composition may then be formed into the multiwall sheet. Alternatively the melt blending and forming of the multiwall sheet may be conducted in a single step in a single manufacturing device.

For example, in manufacturing the electrically conductive composition in a single step, the thermoplastic polymer, blend of thermoplastic polymers or blend of thermoplastic polymer with a thermosetting polymer and the electrically conductive filler may all be added to the melt blending device in a single step and compounded into the electrically conductive composition. The electrically conductive composition may then be formed into a sheet. Alternatively, in an exemplary embodiment related to the manufacturing of the electrically conductive composition in multiple steps, the thermoplastic polymers, blend of thermoplastic polymers or blend of thermoplastic polymer with a thermosetting polymer may first be melt blended with a proportion of the electrically conducted filler in one step and then melt blended with additional electrically conductive filler and any optional antistatic agents or impact modifiers in a second melt blending step. The resulting electrically conductive composition may then be formed into the multiwall sheet. The electrically conductive filler may be added in the form of a masterbatch to the melt blending device.

In an exemplary embodiment, it is desirable to have the melt blending and the forming take place in a single device. Suitable melt blending devices are extruders such as single and twin screw extruders, Buss kneaders, roll mills, Waring blenders, Henschel mixers, helicones, Banbury mixers, or the like, or combinations of the at least one of the foregoing melt blending devices. In one embodiment, the multiwall sheet may be extruded in a single step using a profile die. The preferred extruder is a twin screw extruder. The thermoplastic polymers, blend of thermoplastic polymers or blend of thermoplastic polymer with a thermosetting polymer are generally fed to the throat of the extruder along with the electrically conductive filler and any optional additives. Alternatively, the electrically conductive fillers may be fed to the extruder in masterbatch form. Optional additives such as antistatic agents, impact modifiers, and the like, may also be added in masterbatch form if desired.

In one embodiment related to the manufacturing of multiwall sheets wherein the first and/or the second sheet comprise multiple layers, co-extrusion may be used to produce the multiwall sheet. In co-extruding the multiwall sheet, the layers disposed on the surface of the layer opposite surface in contact with the ribs are preferably those having an electrical resistivity of less than or equal to about 1×10¹¹ ohms/sq.

In one embodiment, during the process of coextrusion it is desirable to match the melt viscosity of the thermoplastic polymer used in the layer disposed upon the layer in contact with the ribs with the melt viscosity of the thermoplastic polymer used in the layer in contact with the ribs during the formation of the multilayer multiwall sheet. In one embodiment, during the process of coextrusion it is desirable to match the melt viscosity of the thermoplastic polymer used in the layer disposed upon the layer in contact with the ribs with the melt viscosity of the thermoplastic polymer used in the layer in contact with the ribs, at the point of initial contact of the two melts during the formation of the multilayer multiwall sheet. In one embodiment, during the process of coextrusion it is desirable for the melt viscosity of the thermoplastic polymer used in the layer disposed upon the layer in contact with the ribs to be within 1% of the melt viscosity of the thermoplastic polymer used in the layer in contact with the ribs during the formation of the multilayer multiwall sheet. In another embodiment, during the process of coextrusion it is desirable for the melt viscosity of the thermoplastic polymer used in the layer disposed upon the layer in contact with the ribs to be within 5% of the melt viscosity of the thermoplastic polymer used in the layer in contact with the ribs during the formation of the multilayer multiwall sheet. In yet another embodiment, during the process of coextrusion it is desirable for the melt viscosity of the thermoplastic polymer used in the layer disposed upon the layer in contact with the ribs to be within 10% of the melt viscosity of the thermoplastic polymer used in the layer in contact with the ribs during the formation of the multilayer multiwall sheet. In yet another embodiment, during the process of coextrusion it is desirable for the melt viscosity of the thermoplastic polymer used in the layer disposed upon the layer in contact with the ribs to be within 20% of the melt viscosity of the thermoplastic polymer used in the layer in contact with the ribs during the formation of the multilayer multiwall sheet.

In one embodiment, in one manner of co-extruding of the multilayered multiwall sheet, the melt streams (extrudates) from the various extruders are fed into a feed block die where the various melt streams are combined before entering the die. In another embodiment, the melt streams from the various extruders are fed into a multi-manifold internal combining die. The different melt streams enter the die separately and join just inside the final die orifice. In yet another embodiment, the melt streams from the various extruders are fed into a multi-manifold external combining die. The external combining dies have completely separate manifolds for the different melt streams as well as distinct orifices through which the streams leave the die separately, joining just beyond the die exit. The layers are combined while still molten and just downstream of the die. An exemplary die used in the production of the multilayered multiwall sheet is a feed block die. In an exemplary embodiment, the extruders used for the co-extrusion of the multiwall sheet are single screw extruders respectively. The co-extruded sheet may optionally be calendared in a roll mill if desired.

In another embodiment, related to the formation of multilayered multiwall sheets, the electrically conductive cap layer may be applied to the first and/or second sheet by processes such as dip coating, chemical vapor deposition, ion beam sputtering, spray painting, electrostatic painting, or the like, or combinations comprising at least one of the foregoing processes.

The thickness of the multiwall sheets as shown in the FIG. 1 is about 1 to about 50 millimeters. In one embodiment, the thickness of the multiwall sheet is about 1.5 to about 30 millimeters. In another embodiment, the thickness of the multiwall sheet is about 2 to about 20 millimeters. In yet another embodiment, the thickness of the multiwall sheet is about 2.5 to about 15 millimeters. The spacing between the ribs is about 2 to about 50 millimeters. In one embodiment, the spacing between the ribs is about 3 to about 30 millimeters. In another embodiment, the spacing between the ribs is about 4 to about 25 millimeters. In yet another embodiment, the spacing between the ribs is about 5 to about 20 millimeters.

It may be desirable for the first sheet to have a higher resistivity than the second sheet or vice versa. As stated above, it is generally desirable for the first and/or the second sheet of the multiwall sheet or the multilayered multiwall sheet to have a surface resistivity of less than or equal to about 1×10¹¹ ohms/sq. In one embodiment, it is generally desirable for the first and/or the second sheet of the multiwall sheet or the multilayered multiwall sheet to have a surface resistivity of less than or equal to about 1×10⁸ ohms/sq. In another embodiment, it is generally desirable for the first and/or the second sheet of the multiwall sheet or the multilayered multiwall sheet to have a surface resistivity of less than or equal to about 1×10⁶ ohms/sq. In yet another embodiment, it is generally desirable for the first and/or the second sheet of the multiwall sheet or the multilayered multiwall sheet to have a surface resistivity of less than or equal to about 1×10³ ohms/sq.

In one embodiment the multiwall sheet has a notched Izod impact strength of greater than or equal to about 4 kilojoules/square meter. In another embodiment, the notched Izod impact strength of greater than or equal to about 6 kilojoules/square meter. In yet another embodiment, the notched Izod impact strength of greater than or equal to about 8 kilojoules/square meter.

In one embodiment, the multiwall sheet has a flex modulus of greater than or equal to about 0.4 Gigapascals (GPa). In another embodiment, the multiwall sheet has a flex modulus of greater than or equal to about 0.6 Gigapascals (GPa). In yet another embodiment, the multiwall sheet has a flex modulus of greater than or equal to about 0.8 Gigapascals (GPa).

In one embodiment, the multiwall sheet has a tensile strength of greater than or equal to about 25 megapascals (MPa). In one embodiment, the multiwall sheet has a tensile strength of greater than or equal to about 35 megapascals (MPa). In one embodiment, the multiwall sheet has a tensile strength of greater than or equal to about 45 megapascals (MPa). In one embodiment, the multiwall sheet has a tensile elongation of greater than or equal to about 5%. In one embodiment, the multiwall sheet has a tensile elongation of greater than or equal to about 7%. In one embodiment, the multiwall sheet has a tensile elongation of greater than or equal to about 8%.

As stated above, the multiwall sheet may advantageously used for packaging of the electronic, automotive components and other areas where the build-up of electronic charges and electrostatic discharge of the material can lead to serious problems in a specific application. The multiwall and multilayer multiwall sheet thus formed may also be subjected to additional processing such as thermoforming, vacuum molding, blow molding, shaping, and the like, to produce materials having different shapes and geometries.

The following examples, which are meant to be exemplary, not limiting, illustrate compositions and methods of manufacturing some of the various embodiments of the multilayered sheets using various materials and apparatus.

### EXAMPLES

This example was undertaken to demonstrate the advantage of a multiwall sheet derived from polycarbonate (PC) over competitive products that are commercially available. The competitive product is a commercially available polypropylene multiwall sheet. Table 1 shows the compositions and/or the brand names of various matrials that were made into multiwall sheets. FC-1 is a monomeric antistatic agent commercially available from Haining Fengshi Fire Retardant Chemical Factory in China. StatLoy® is a commercially available product comprising acrylonitrile butadiene styrene (ABS) and a polymeric antistatic agent. Statkon®-PDX-D02437 is a commercially available product comprising polycarbonate and carbon powder while Statkon®-DC-1004 EM is a commercially available product comprising polycarbonate and carbon fiber. A multiwall sheet made from polycarbonate (without any electrically conductive filler) was also coated with Exxene HCESD-100, an antistatic coating commercially available from Exxene Corporation. The coating was applied by flow coating, roll coating or spray coating. Thickness of the coatings were 0.1 to 10 micrometers.

TABLE 1

| | | | StatLoy ®-A | Statkon ® -PDX- | Statkon ® -DC- | PC sheet with an |
|---|---|---|---|---|---|---|
| Composition | Polycarbonate | PC + FC-1 | Clear | D02437 | 1004 EM | antistatic coating |
| Thermoplastic | 100 wt % | | Less than 95 wt % | Less than 95 wt % | Less than 95 wt % | PC |
| Resin | PC | | ABS | PC | PC | |
| Conductive | none | FC-1 | Polymeric | Carbon powder | Carbon fiber in | Antistatic |
| filler | | (Monomeric | antistatic additive | in the range of | the range of 5-50 wt % | coating from |
| | | antistatic | in the range of | 5-40 wt % | | Exxene HCESD- |
| | | additive) | 5-40 wt % | | | 100 |

The products listed in the Table 1 were extruded in a single screw extruder. The barrel temperatures were set at 250 to 320° C., respectively, from the throat of the extruder to the die. The die temperature was set at 220 to 260° C. The screw speed was set at 20 rpm. A profile die was used at the exit of the extruder to provide the multiwall sheet.

Surface resistivity was measured and calculations were performed according to ASTM D 257 on a Keithley apparatus, model 65. The surface resistivity of the multiwall sheet was measured by placing a section of the multiwall sheet between two electrodes. The applied test voltage between the electrodes was 500 Volts. Measurements were carried out at 50% relative humidity (RH) and 23° C. Static decay was measured on a static decay apparatus. During this measurement a voltage of 10,000 volts was applied to charge the part. Then the time was measured which required to part to discharge to 5,000 volts. Measurement were carried out at 50% RH and 23° C.

The results from the tests are shown in Table 2.

TABLE 2

| | | | | StatLoy ® | StatKon ® | StatKon ® | |
|---|---|---|---|---|---|---|---|
| | Polypropylene | Polycarbonate | PC + FC-1 | ABS | MWS | MWS | PC |
| Property | MWS | MWS | MWS | MWS | (powder) | (fibre) | MWS + coating |
| Hardness | Low | High | High | Medium | High | High | High |
| Surface | greater | greater than | greater | greater | less than | greater | less |
| resistivity | than | 10\hat{ }15 | than | than | 10\hat{ }6 | than | than |
| | 10\hat{ }10 | | 10\hat{ }10 | 10\hat{ }10 | | 10\hat{ }15 | 10\hat{ }9 |
| Surface | greater | greater than | greater | greater | less than | greater | less |
| resistivity | than | 10\hat{ }15 | than | than | 10\hat{ }6 | than | than |
| after | 10\hat{ }15 | | 10\hat{ }15 | 10\hat{ }10 | | 10\hat{ }15 | 10\hat{ }9 |
| washing | | | | | | | |
| with | | | | | | | |
| water | | | | | | | |
| (ohm/sq) | | | | | | | |
| Static | 0.8 | greater than | 10 | 5.6 | 0 | greater | 0 |
| decay | | 2000 | | | | than 2000 | |
| (seconds) | | | | | | | |
| Static | greater | greater than | greater | 4.8 | 0 | greater | 0 |
| decay | than 2000 | 2000 | than | | | than 2000 | |
| after | | | 2000 | | | | |
| washing | | | | | | | |
| with | | | | | | | |
| water | | | | | | | |
| (seconds) | | | | | | | |

The results in Table 2 show that the multiwall sheets manufactured from the Statkon®-PDX-D02437 containing polycarbonate and carbon powder and the polycarbonate sheet coated with the antistatic coating both have superior properties when compared with the remaining multiwall sheets.

As stated above, the multiwall sheet displays numerous advantages that permit to be used for packaging electronics and automotive components. As stated above, the multiwall sheet has a surface resistance of less than or equal to about 1×10¹¹ ohms/sq, while having a tensile strength of greater than or equal to about 25 megapascals (MPa), notched Izod impact strength of greater than or equal to about 4 kilojoules/square meter and a flex modulus of greater than or equal to about 0.4 Gigapascals (GPa).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A multiwall sheet comprising:
a first sheet having a first side and a second side, wherein the first sheet comprises a thermoplastic polymer and an electrically conductive filler, and wherein the first side of the first sheet is disposed upon a first side of a plurality of ribs; and
a second sheet having a first side and a second side, wherein the second sheet comprises a thermoplastic polymer and an electrically conductive filler, wherein the first side of the second sheet is disposed upon a second side of the plurality of ribs, and wherein the first side of the plurality of ribs is opposed to the second side of the plurality of ribs.

2. The multiwall sheet of claim 1, wherein the thermoplastic polymer comprises a blend of thermoplastic polymers.

3. The multiwall sheet of claim 2, wherein an electrically conductive filler is added to a single phase of the blend of thermoplastic polymers.

4. The multiwall sheet of claim 1, wherein the thermoplastic polymer is polyacetal, polyacrylic, polycarbonate, polystyrene, polyester, polyamide, polyamideimide, polyarylate, polyarylsulfone, polyethersulfone, polyphenylene sulfide, polyvinyl chloride, polysulfone, polyimide, polyetherimide, polytetrafluoroethylene, polyetherketone, polyether etherketone, polyether ketone ketone, polybenzoxazole, polyoxadiazole, polybenzothiazinophenothiazine, polybenzothiazole, polypyrazinoquinoxaline, polypyromellitimide, polyquinoxaline, polybenzimidazole, polyoxindole, polyoxoisoindoline, polydioxoisoindoline, polytriazine, polypyridazine, polypiperazine, polypyridine, polypiperidine, polytriazole, polypyrazole, polypyrrolidine, polycarborane, polyoxabicyclononane, polydibenzofuran, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfone, polysulfonamide, polyurea, polyphosphazene, polysilazane, or a combination comprising at least one of the foregoing thermoplastic polymers.

5. The multiwall sheet of claim 1, wherein the thermoplastic polymer is bisphenol A polycarbonate, copolyestercarbonate, or a blend of polyester with polycarbonate.

6. The multiwall sheet of claim 5, wherein the polyester is a cycloaliphatic polyester, a polyarylate or a combination of a cycloaliphatic polyester with a polyarylate.

7. The multiwall sheet of claim 1, wherein the electrically conductive filler is carbon black, carbon nanotubes, metallic fillers, metallic conductive fillers, non-metallic conductive fillers, non-conductive fillers coated with metals, or a combination comprising at least one of the foregoing fillers.

8. The multiwall sheet of claim 1, wherein the carbon nanotubes are single wall carbon nanotubes, multiwall nanotubes, vapor grown carbon fibers, or a combination comprising at least one of the foregoing carbon nanotubes.

9. The multiwall sheet of claim 1, wherein the first and/or the second sheet have a surface resistivity of less than or equal to about 1×10¹¹ ohm/sq.

10. The multiwall sheet of claim 1, wherein the thickness of the sheet is about 1 to about 50 millimeters, and the distance between successive ribs is about 2 to about 50 millimeters and wherein the multiwall sheet has a surface resistance of less than or equal to about 1×10¹¹ ohms/sq, while having a tensile strength of greater than or equal to about 25 megapascals, a notched Izod impact strength of greater than or equal to about 4 kilojoules/square meter and a flex modulus of greater than or equal to about 0.4 Gigapascals.

11. The multiwall sheet of claim 1, wherein the first and/or the second sheet further comprise additives, and wherein the additives are antistatic agents, ultraviolet absorbers, antioxidants, flame retardants, anti-drip agents, anti-ozonants, thermal stabilizers, anti-corrosion additives, impact modifiers, mold release agents, flow promoters, pigments, dyes or a combination comprising at least one of the foregoing additives.

12. The multiwall sheet of claim 1, wherein the first sheet and/or the second sheet are fused with the ribs.

13. A method of manufacturing an electrically conductive multiwall sheet comprising:
melt blending a thermoplastic polymer with an electrically conductive filler to form an electrically conductive composition; and
forming the electrically conductive composition into a multiwall sheet, wherein the multiwall sheet comprises a first sheet having a first side and a second side, wherein the first sheet comprises a thermoplastic polymer and an electrically conductive filler, and wherein the first side of the first sheet is disposed upon a first side of a plurality of ribs; and a second sheet having a first side and a second side, wherein the second sheet comprises a thermoplastic polymer and an electrically conductive filler, wherein the first side of the second sheet is disposed upon the second side of the plurality of ribs, and wherein the first side of the plurality of ribs is opposed to the second side of the plurality of ribs.

14. The method of claim 13, wherein the melt blending and the forming are performed in a single device.

15. The method of claim 14, wherein the single device is an extruder.

16. The method of claim 13, further comprising depositing additional electrically conductive layers on the second surface of the first and/or second sheet.

17. The method of claim 13, further comprising thermoforming, vacuum molding, blow molding, or shaping the multiwall sheet.

18. The method of claim 13, wherein additional sheets are disposed parallel to the first and second sheet, and wherein the additional sheets are located in between the first sheet and the second sheet.

19. A method of manufacturing an electrically conductive multiwall sheet comprising:
forming a thermoplastic polymer into a multiwall sheet, wherein the multiwall sheet comprises a first sheet having a first side and a second side, wherein the first side of the first sheet is disposed upon a first side of a plurality of ribs; and a second sheet having a first side and a second side, wherein the first side of the second sheet is disposed upon the second side of the plurality of ribs, and wherein the first side of the plurality of ribs is opposed to the second side of the plurality of ribs; and
coating the second side of the first and/or second sheet with a conductive coating having a surface resistivity of less than or equal to about 10¹¹ ohm/sq.

20. The method of claim 19, wherein the conductive coating comprises indium tin oxide.

21. The method of claim 19, wherein the forming is accomplished by coextrusion.

22. A method for manufacturing a multilayered multiwall sheet comprising:
co-extruding a multilayered multiwall sheet comprising a first sheet having a first side and a second side, wherein the first sheet comprises a thermoplastic polymer and an electrically conductive filler, and wherein the first side of the first sheet is disposed upon a first side of a plurality of ribs; and a second sheet having a first side and a second side, wherein the second sheet comprises a thermoplastic polymer and an electrically conductive filler, wherein the first side of the second sheet is disposed upon the second side of the plurality of ribs, and wherein the first side of the plurality of ribs is opposed to the second side of the plurality of ribs.

23. The method of claim 22, wherein the thermoplastic polymer is bisphenol A polycarbonate, copolyestercarbonate, or a blend of polyester with polycarbonate.

24. The method of claim 23, wherein the polyester is a cycloaliphatic polyester, a polyarylate or a combination of a cycloaliphatic polyester with a polyarylate.

25. The method of claim 22, further comprising calendaring the multilayered multiwall sheet.

26. An article manufactured by the method of claim 13.

27. An article manufactured by the method of claim 19.

28. An article manufactured by the method of claim 22.
